(19) United States
(12) Patent Application Publication
(10) Pub. No.: US 2004/0121674 A1
(43) Pub. Date: Jun. 24, 2004

(54) Composite engine component and method for making the same

(76) Inventor: Jeffrey R. Robbins, Ann Arbor, MI (US)

Correspondence Address: Eric R. Moran, McDonnell Boehnen Hulbert & Berghoff, 32nd Floor, 300 S. Wacker Drive, Chicago, IL, 60606, US

(21) Appl. No.: 10/323,472

(22) Filed: Dec. 18, 2002

(51) Int. Cl. B32B 5/12; D04H 1/00; B32B 5/02; B32B 27/12; B32B 27/04; B32B 15/14; B32B 5/26

(52) U.S. Cl. 442/38; 442/43; 442/45; 442/51; 442/58

(57) ABSTRACT

A composite vehicle component that is capable of attenuating RFI waves, and a method for making the same, is provided. The composite vehicle component can, in turn, comprise a composite structure and a conductive mesh attached to the composite structure, such that the conductive mesh, when contacted to ground, can attenuate RFI waves.

### BACKGROUND

1. Field of the Invention

The present invention relates to composite vehicle components, and more specifically, to a composite vehicle component formed with a conductive mesh.

2. Description of the Related Art

Electrical components in a vehicle, and specifically in a vehicle engine, may generate radio frequency interference (“RFI”). The RFI, in turn, may interfere electronically with other vehicle components, such as a vehicle radio or an on-board computer. The RFI might also interfere with electrical or communications equipment outside of a vehicle. For example, RFI generated by one vehicle might interfere with the communication transmissions of fire, police, or other emergency services.

Composite components, and specifically composite engine components, are often used advantageously in vehicles. For example, composite components can be used to reduce the weight of a vehicle, and hence might make the vehicle more fuel-efficient. Disadvantageously, however, composite components generally fail to absorb RFI waves and allow RFI waves to interfere with other vehicle components and to potentially escape from the engine area of a vehicle. There thus exists a need for a composite component that can capture and ground RFI generated by electrical components in a vehicle.

### SUMMARY

An exemplary embodiment comprises a composite vehicle component that is capable of attenuating RFI waves. The composite vehicle component can, in turn, comprise a composite structure and a conductive mesh attached to the composite structure, such that the conductive mesh, when contacted to ground, can attenuate RFI waves.

### BRIEF DESCRIPTION OF THE DRAWINGS

Exemplary embodiments of the present invention are described herein with reference to the drawings, in which:

FIG. 1 is an isometric view of a composite component with a cutaway showing a conductive mesh;

FIG. 2 is an illustration of an exemplary conductive mesh that might be formed into a composite component;

FIG. 3 is an illustration of a portion of a cross-section of a composite component with a conductive mesh; and

FIG. 4 is a flowchart illustrating a process carried out in accordance with an exemplary embodiment.

### DETAILED DESCRIPTION OF EXEMPLARY EMBODIMENTS

### 1. Exemplary Embodiments

A composite component 10 of the present invention is shown in FIG. 1. The composite component 10 includes a composite structure 11 and a conductive mesh 12, as shown in the cutaway in FIG. 1. The conductive mesh 12 can be, for example, attached to the composite structure 11 of the composite component 10 by being integrally formed with the composite structure 11. The conductive mesh 12 can also be attached to the composite structure 11 in another way. In an exemplary embodiment, the composite component 10 might comprise a component in a vehicle engine, such as a valve cover. And in an exemplary embodiment, the mesh 12 may be molded into the composite component 10. In another embodiment, the mesh 12 may be attached to the composite structure 11 with a glue such as vinyl ester, for example, or, in the case of a thermoplastic composite component, the mesh 12 may be heated and pressed into the composite structure 11. The mesh 12 may then be used to capture and ground RFI waves produced by electrical components in the engine.

FIG. 2 shows an example of a type of mesh 12 that might be attached to the composite component 10. The mesh 12 can comprise a conductive material, such as aluminum, brass, copper, or copper beryllium. Other materials are possible as well.

In an exemplary embodiment, the mesh 12 can comprise spaced-apart, crossing wire conductors, similar to a screen. In other embodiments, the mesh 12 might comprise different geometries. For example, the mesh 12 might simply comprise one or more strands of conductive material. As another example, the mesh 12 might comprise a band or sheet of conductive material, and the band or sheet might further comprise pores or holes punched through it. Other examples are also possible.

RFI generally comprises a series of waves with various amplitudes and frequencies. The spacing between conductors, or the pore or hole size in the conductive material, can be optimized by determining the frequency distribution of the RFI that might be expected to interfere with vehicle components, determining the wavelength(s) of such RFI, and adjusting the spacing, hole, or pore size of the mesh 12 to attenuate such RFI. Similarly, the thickness of the mesh 12 may be optimized by determining the amplitude of the type of RFI waves that might be expected to interfere with vehicle components, and adjusting the thickness of the mesh 12 to attenuate such RFI.

As depicted in the exemplary embodiment of FIG. 2, the mesh 12 can comprise a generally flat surface. In another embodiment, the mesh 12 can comprise a preformed surface that can generally correspond to the shape of a composite component to be molded.

FIG. 3 shows a portion of a cross-section of the composite component 10 with the conductive mesh 12. As shown in FIG. 3, the mesh 12 can be located between an outer surface 14 and an inner surface 16 of the composite component 10. Although FIG. 3 shows the mesh 12 generally equidistant from outer surface 14 and inner surface 16, the mesh 12 might also be located closer to one of the surfaces than the other. The mesh 12 might also be formed into or attached to either, or both, the outer surface 14 and/or the inner surface 16.

Returning to FIG. 1, the mesh 12 can cover the entire extent of the composite component 10. Alternatively, the mesh 12 might cover only a portion of the composite component 10. In addition, more than one mesh 12 can be attached to the composite component 10, either in two or more layers or in different portions of the composite structure 11 of the composite component 10. In addition, the mesh 12 can optionally form a three-dimensional grid, depending upon the need and the particular application.

Further, the mesh 12 may also be connected to a ground or other electrical dampening components. A path to ground may be accomplished in any number of ways. In one embodiment, the path to ground might run through one or more bolts and/or bolt sleeves 13 that are attached to the composite component 10 and that contact the conductive mesh 12. The bolts and/or bolt sleeves 13 might then form a conductive path to the vehicle chassis or engine block. Further, a ground strap might connect the vehicle bolts and/or bolt sleeves 13 to the vehicle chassis or engine block. As another example, a jumper might connect a bolt head to the vehicle chassis or engine block. As still another example, a ground strap can be molded into, bolted to, or otherwise attached to the composite component 10 and then connected to the vehicle chassis or engine block. Other examples are possible as well.

The mesh 12 in composite component 10 can be used to capture and ground RFI that might be generated by electrical components in the vehicle engine. In an exemplary embodiment, spark plugs in a vehicle engine might generate RFI, and a conductive mesh 12 attached to a composite valve cover can then be used to capture and ground the RFI. In other embodiments, other electrical component(s) might generate RFI, and other composite component(s) with conductive mesh(es) might then capture and ground the RFI. Other examples are possible, as well.

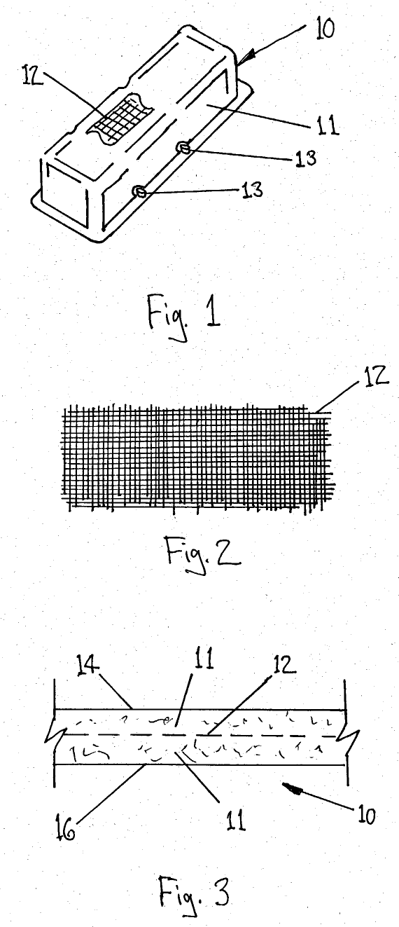

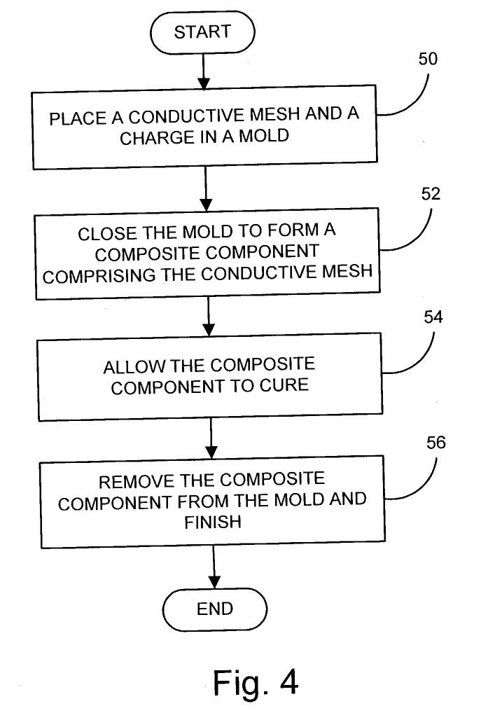

2. Exemplary Processes for Forming the Exemplary Embodiments FIG. 4 depicts a diagram of an exemplary process for forming a composite component 10 with a conductive mesh 12. The exemplary process shown in FIG. 4 comprises a compression molding process using a thermoset molding compound. The thermoset molding compound might be sheet molding compound (“SMC”) or bulk molding compound (“BMC”), for example. Other processes for forming the composite component 10 are possible, as well. For instance, the composite component 10 with the conductive mesh 12 might be formed by an injection molding process using either a thermoset or thermoplastic injection molding material. Or the composite component 10 with the conductive mesh 12 might be formed by a thermoplastic compression molding process. The thermoplastic compression molding process may also use a nylon composite, for instance.

At block 50 of FIG. 4, the mesh 12 and a charge (the unformed composite material, which may comprise a thermoset such as SMC or BMC, for example) are placed in a molding tool that comprises a mold of a component. As discussed above, the mesh 12 might be a generally flat sheet that could then be placed in or draped on the mold. The mesh 12 might also be preformed to the same general shape as the mold. In any case, the mesh 12 may be positioned in the mold underneath the charge, above the charge, or between two or more charges. Further, the charge may not cover the entire inside surface area of the mold. For instance, the charge may be positioned generally in the middle of the mold. And several layers, or sheets, of the charge may be stacked in the mold.

At block 52, the mold tool is closed and the composite component 10 is formed. When the mold tool is closed, the mold tool can exert a pressure on the charge and mesh 12. For example, an SMC mold tool might exert a pressure of about 1000 psi on the charge and mesh 12. Other processes might use different pressures. When the mold tool is closed, the mold may then be heated. For example, the mold in the SMC mold tool may be heated to about 300 degrees Fahrenheit. Other processes might use different pressures. The mold tool might also be closed for a predetermined period of time. In an exemplary embodiment, the SMC mold tool might be closed for about 30 to 90 seconds. The mold tools in other processes might be closed for different periods of time.

At block 54, the composite component 10 is allowed to cure. Cure times may vary. Once cured, the composite component 10 becomes rigid. At block 56, the composite component 10 can then be removed from the mold tool and finished. Finishing might comprise trimming excess composite material and/or mesh, and punching through the material and/or mesh as necessary.

The composite component 10 may also be formed by molding processes other than compression molding using a thermoset. For instance, in another embodiment, the charge might comprise a thermoplastic, such as a nylon composite. In such a case, the thermoplastic charge might be heated prior to placement in the mold tool, instead of being heated by the mold tool. Once heated, the thermoplastic charge might be placed in the mold tool with the conductive mesh 12 as described above. The mold tool might then close and form the composite component 10, and the composite component 10 might then cool and set in the closed mold.

In another embodiment, the composite component 10 might be formed by injection molding. In such a case, a preformed conductive mesh 12 might be placed in a cavity of a mold that fluidly communicates with an injector. Thermoplastic or thermoset injection molding material might then flow from the injector into the cavity. The material might then cool or cure, forming the composite component 10 with the mesh 12.

### 3. Conclusion

Several exemplary embodiments of the present invention have been described above. Those skilled in the art will understand, however, that changes and modifications may be made to these embodiments without departing from the true scope and spirit of the present invention, which is defined by the claims.

I claim:

1. A composite vehicle component that is capable of attenuating RFI waves comprising:
(a) a composite structure; and
(b) a conductive mesh attached to the composite structure, such that the conductive mesh, when contacted to ground, attenuates RFI waves.

2. The composite vehicle component of claim 1, wherein the conductive mesh is formed into at least a portion of the composite structure.

3. The composite vehicle component of claim 2, wherein the conductive mesh is completely embedded in the composite structure.

4. The composite vehicle component of claim 2, wherein the conductive mesh is formed into the inner surface of the composite structure.

5. The composite vehicle component of claim 2, wherein the conductive mesh is formed into the outer surface of the composite structure.

6. The composite vehicle component of claim 1, further comprising a plurality of conductive meshes attached to the composite structure, such that the conductive meshes, when contacted to ground, attenuate RFI waves.

7. The composite vehicle component of claim 1, wherein the conductive mesh comprises spaced-apart, crossing wire conductors.

8. The composite vehicle component of claim 1, wherein the conductive mesh comprises at least one strand of conductive material.

9. The composite vehicle component of claim 1, wherein the conductive mesh comprises a band of conductive material.

10. The composite vehicle component of claim 1, wherein the conductive mesh comprises a sheet of conductive material.

11. The composite vehicle component of claim 1, wherein the conductive mesh comprises a three-dimensional grid.

12. The composite vehicle component of claim 1, wherein the conductive mesh comprises a preformed conductive mesh.

13. The composite vehicle component of claim 1, wherein the composite vehicle component comprises a valve cover.

14. A method for forming a composite vehicle component capable of attenuating RFI waves comprising:
(a) forming a conductive mesh;
(b) forming a composite structure; and
(c) attaching the conductive mesh to the composite structure, such that the conductive mesh, when contacted to ground, attenuates RFI waves.

15. The method of claim 14, wherein the composite vehicle component is formed by compression molding.

16. The method of claim 14, wherein the composite vehicle component is formed by injection molding.

17. The method of claim 14, wherein the conductive mesh is attached to the composite structure by molding the conductive mesh integrally into the composite structure as the composite structure is being formed.

18. The method of claim 17, wherein the conductive mesh is completely embedded in the composite structure.

19. The method of claim 17, wherein the conductive mesh is formed into the inner surface of the composite structure.

20. The method of claim 17, wherein the conductive mesh is formed into the outer surface of the composite structure.

21. The method of claim 14, wherein the conductive mesh comprises a preformed conductive mesh.

22. The method of claim 14, wherein the composite vehicle component comprises a valve cover.
